(19) United States
(12) Patent Application Publication
(10) Pub. No.: US 2008/0092595 A1
(43) Pub. Date: Apr. 24, 2008

(54) Nozzle and method for producing optical glass gob using the nozzle

(75) Inventor: Ryousuke Sakai, Kanagawa (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Ohara Inc.

(21) Appl. No.: 11/907,779

(22) Filed: Oct. 17, 2007

(30) Foreign Application Priority Data
Oct. 20, 2006 (JP) 2006-286466
Mar. 26, 2007 (JP) 2007-078360

(51) Int. Cl. C03B 7/14; C03B 17/00

(52) U.S. Cl. 65/66; 65/304

(57) ABSTRACT

A high-quality glass gob is easily obtained that is adapted to glass of recent years having higher refractive indices or lower Tg of which the molding temperature is close to or below the temperature of liquid phase. A nozzle, which is connected to a bath of molten glass to flow out the molten glass, has a site disposed where the center of gravity of a cross-section, which is perpendicular to the flow-out direction of the molten glass in the flow path within the nozzle, is shifted from the center of gravity of the cross-section of upstream side. A method for producing a glass shaped body includes steps of melting a raw material of glass within a bath of molten glass, flowing out the molten glass into a molding tool through a nozzle connected to the bath of molten glass, and molding the glass shaped body.

This application is based on and claims the benefit of priority from Japanese Patent Application No. 2006-286466, filed on 20 Oct. 2006, and Japanese Patent Application No. 2007-078360, filed on 26 Mar. 2007, the content of which is incorporated herein by reference.

### BACKGROUND OF THE INVENTION

1. Field of the Invention

The present invention relates a technology to produce optical glass gob in a predetermined amount.

2. Related Art

In recent years, miniaturization and weight saving have been demanded in the field of optical apparatuses such as digital cameras and projectors; consequently, the market of aspherical lenses has been growing since the number of lenses in use can be decreased.

In general, lenses for constructing optical systems are typically classified into spherical lenses and aspherical lenses. A number of spherical lenses are produced by molding a glass material through reheat press-molding to form a glass shaped body, which is then ground and polished. On the other hand, aspherical lenses are produced mainly by precision press-molding, i.e. press-molding a heated and softened preform by use of a mold with a highly precise molding face, thereby transferring the shape of the molding surface of the mold to the preform material.

Spherical, ellipsoidal, or flattened glass shaped bodies (glass gobs) are often used as preforms for precision press-molding; these shaped bodies can be produced by melting raw materials in melting devices such as crucibles to form a glass, flowing the glass onto a molding tool from a nozzle connected to the melting devices to form plate-like glass, rod-like glass, or the like, which are further cold-worked. In recent years, such technologies have also been employed as cutting the molten glass which is flowed out from a nozzle, etc. by use of a shear, or separating by making use of surface tension, for example, flowing (dropping) down onto a gas-ejecting porous mold to float-shape the molten glass, thereby preparing glass gobs with an appropriate size and shape. In this regard, the former may leave cutting traces due to shears; therefore, the latter has mainly been employed in recent years.

In order to control temperature, flow amount, etc. or to prevent undesirable occurrences such as striae and devitrification when glass is flowed out from nozzles in any processes described above, various configurations have been proposed for the nozzles. In recent years, various technologies have been proposed to address higher temperatures of liquid phase and/or lower viscosities associated with higher refractive indices or lower viscosities associated with lower Tg; however, these proposals are insufficient at present.

Patent Document 1 describes a nozzle capable of controlling a delay in timing when glass starts to flow down, by way of enlarging the flow-outlet diameter to larger than the nozzle-body diameter, for example, by opening to be taper-shaped the outlet of molten glass at the nozzle tip.

Patent Document 2 describes a method to prevent occurrences of striae by way of disposing a restriction inside a melting device to uniformly distribute velocity and to suppress residence of glass, which is degraded through evaporating a portion of constituents thereof, while molten glass starts to flow in the melting device and out from a flow outlet through a pipe. It is also described that the temperature around the restriction portion is controlled to be higher than the other portions so as to prevent a reduction of flow rate due to the restriction.

Patent Document 3 describes a method to increase the maximum weight of obtainable glass gobs by way of disposing a resistant member inside a nozzle and reducing the flow rate of glass flowing at the central cross section of the nozzle.

Patent Document 4 describes a small device to control flow-rate having such a configuration in which an enlarged portion with a cross section larger than the tip portion is provided between a portion to connect with a bath to contain molten glass and a tip portion of an outlet so as to control temperatures of various portions.

Patent Document 1: Japanese Unexamined Patent Application Publication No. Hei 10-36123

Patent Document 2: Japanese Unexamined Patent Application Publication No. 2003-306334

Patent Document 3: Japanese Unexamined Patent Application Publication No. Hei 08-26737

Patent Document 4: Japanese Patent Publication No. Hei 08-25750

However, there exist the following problems in the previous methods described above.

It is necessary in general for shaping molten glass by a molding tool while flowing out from the molten glass from a melting bath through a nozzle to control the temperature of the molten glass as to come down gradually from the melting bath to the flow outlet into a temperature suited to the shaping. In such processes, striae derived by evaporation of glass constituents after the flowing out, which should be addressed by lowering the nozzle temperature to be controlled, may be caused. However, the stream of molten glass is typically a stream of highly viscous fluid from higher temperature side to lower temperature side, and the temperature inside nozzles is lower around an inner wall and higher around the center of gravity of cross section. In regards to the distribution of flow velocity, the flow velocity is lower around the inner-wall surface and higher around the center of gravity of cross section.

When being controlled based on nozzle temperature, the temperature measured for nozzles may correctly represent the glass temperature around the inner-wall surface; however, the temperature is different from and lower than the temperature at the center of glass stream (i.e. the temperature of the glass stream that passes through near the center of gravity of cross section). Consequently, the glass having a higher temperature of liquid phase may cause devitrification, since the nozzle temperature (glass temperature around inner surface of nozzles) is cooled to a crystal-growing temperature, i.e. the so-called devitrification temperature, before the center of the glass stream is cooled to the temperature at which no volatiles appear.

In regards the nozzle described in Patent Document 1, the flow outlet is opened to be taper-shaped to enlarge the inner diameter; therefore, the temperature difference and the flow-velocity difference increase between the inner-wall surface and at the center of glass stream, thus the tendency described above becomes more significant.

In a case where such a nozzle is used that has a restriction as described in Patent Document 2, the velocity distribution of the flowing-out glass stream may be effectively uniformalized; however, it is difficult to prevent striae derived by volatiles while flowing out, since a higher-temperature glass stream is taken out from around the center of gravity of the cross section of the nozzle. When the control temperature is lowered so as to suppress volatilization, the devitrification tends to occur and grow immediately, which easily clogs the flow path at the restricting portion and tends to stop flow-out itself. In the example, the temperature around the restriction portion is controlled to be higher than the other portions so as to prevent flow-rate drop due to the restriction, which clearly indicates that, in recent years, the method has been inappropriate to produce glass with higher refractive indices.

In the nozzle described in Patent Document 3, the flow-down velocity of molten glass is delayed at a central portion by a resistant member disposed at the inside center; the velocity distribution of flow-out velocity may be uniformalized; however, the temperature of the center of the glass stream immediately becomes higher when the resistant member is small-sized and made mainly of precious metal of low heat capacity. Therefore, the effect to lower the temperature of the center of glass stream is unobtainable, and there exists no effect to suppress the striae derived by volatiles. Furthermore, it is necessary that the resistant member be fixed by way of a supporting member as shown in FIG. 3 of Patent Document 3, thus it is very difficult to develop a nozzle for flowing out glass made mainly of precious metal such as platinum. Furthermore, claim 4 of Patent Document 3 is characterized in that a plurality of nozzles is provided at a bottom portion of a crucible, and respective tip portions of the nozzles are connected to each other to form one nozzle hole; however, higher-temperature glass streams generate at the respective centers of the nozzles, thus there appears no effect to lower the temperature of the center of flowing-down glass stream. When such a complicated configuration is applied, it is very difficult to modify the configuration for adjusting the temperature, viscosity, wetting, density, and liquid pressure of glass, thus flow velocity and temperature distribution also become complicated, and therefore more simplified configuration has also been demanded from this viewpoint.

The configuration described in Patent Document 4 imposes an assumption for controlling the flow-rate in that the temperature of the flow outlet is higher than that of the enlarged portion. However, the moldable temperature of recent glass with high refractive indices is close to the temperature of the liquid phase; therefore, when the temperature of the flow outlet (molten glass stream to be flowed out) is the molding temperature, the temperature at the enlarged portion, which is lower than the temperature, is below the temperature of the liquid phase, which results in devitrification at the enlarged portion and remarkably degrading optical properties.

The present invention provides a nozzle for simply producing high-quality glass gobs adapted to glass of recent with higher refractive indices or glass with lower Tg of which the molding temperature (or temperature at flow outlet) is close to or reverse with the temperature of liquid phase. In addition, it is an object of the present invention to provide a nozzle for conventional glass that can simply within a short distance control, thereby downsizing systems.

### SUMMARY OF THE INVENTION

The present inventors have found that a distribution of temperature and flow velocity can be uniformalized and also a desirable distribution of temperature and flow velocity can be realized by way of taking the glass around an inner wall of the flow path, which is sufficiently controlled and measured, without directly flowing out the higher temperature center of the glass stream from a flow outlet; consequently, disadvantages such as striae can be suppressed, and thus the problems described above can be solved.

In a first aspect of the present invention, a nozzle is provided that is connected to a bath of molten glass to flow out the molten glass, and a site is disposed where a center of gravity of a cross-section, which is perpendicular to a flow-out direction of the molten glass in a flow path within the nozzle, is shifted from the center of gravity of the cross section of an upstream side.

As described above, in the configuration of the first aspect of the present invention, there is provided such a nozzle that when the cross-section perpendicular to the flow path of the molten glass within the nozzle is compared to the cross-section at a site upstream thereof, the center of gravity of the cross-section of the flow path is shifted. When such a configuration is employed, the flow path of the higher-temperature glass stream, which has flowed at the site through around the center of the cross section of the nozzle, is forcibly shifted to around the inner wall of the nozzle and mixed with the lower-temperature glass stream, which leads to a more uniform temperature distribution at the site. Thereafter, a desirable distribution of temperature and flow velocity may be obtained by means of constructing the flow-out portion (flow outlet) with an appropriate diameter, length, shape, and temperature-control process. Consequently, defects such as striae and devitrification are unlikely to appear.

In this specification, the term “nozzle” refers to a concept that includes an entire flow path and a flow outlet, which are connected to a melting bath for melting and/or supporting molten glass, in order to flow a glass stream when the molten glass is flowed out into a mold. That is, so-called pipes and orifices are included as the “nozzle”.

In this specification, the expression “center of gravity of the cross-section is shifted” means that when the center of gravity of the cross-section, perpendicular to the flow-out direction in the flow path within the nozzle, is compared along the flow-out direction, the position of the center of gravity of the cross-section is changed at a predetermined site. Such a configuration assumes that a baffle plate is disposed at a site within a cylindrical flow path, for example.

In a second aspect of the nozzle according to the present invention, a plurality of sites is disposed where the center of gravity of the cross-section in the flow path is shifted.

The nozzle, with the configuration of the second aspect of the present invention, has a plurality of sites where the glass stream can change the flow path. When a plurality of sites is provided, the difference of flow velocities of the glass may be effectively reduced, even under the condition of a mild temperature slope in the flow direction, a little shifting amount, or a low shift accuracy, and the glass temperature may be more uniformalized within the nozzle, thus an intended temperature distribution of glass stream is easily realized. In this regard, an excessively large number of the sites may disturb smooth progress of the glass stream by contrast, and also the configuration of the nozzle itself becomes complex and unfeasible. It is therefore preferable that the number of the sites is no more than 10 in an entire nozzle, more preferably no more than 8, and most preferably no more than 6.

In a third aspect of the nozzle according to the first or second aspect of the present invention, at least one site, where the center of gravity of cross-section is shifted, has a cross-section area of a flow path of no more than 90% based on the cross-section area of a flow path of the upstream side.

The third aspect of the nozzle according to the first or second aspect of the present invention is defined for a specific embodiment as to the nozzle configuration of which the center of gravity of cross-section is shifted. That is, there exists a site, where the flow path is rapidly narrowed in the flow path within the nozzle, in the third aspect of the nozzle of the present invention, and it is defined in that one or more sites exist where the cross-section area of the narrowed portion is no more than 90% based on that of the other portions. In this aspect, the site is necessary to be shifted for the center of gravity of cross-section from that upstream, and thus a structure is employed that is clearly different from the restriction at the center of flow path within a pipe as described in the Patent Document 2.

The reason for which the cross-section area at the narrowed portion, i.e. the site capable of changing the flow path of the glass stream is defined as no more than 90%, is that the configuration with no effect significant on the flow condition of glass may be unobtainable for the intended effect of the present invention. That is, the present inventors believe that there exists a boundary film around the inner wall of the nozzles where traveling rate of glass is very small and also temperature drop is large from the center of glass stream, and this influence makes it difficult to correctly measure and control the temperature throughout the glass stream (including a glass stream flowing around the center of gravity of cross-section in particular).

It is therefore necessary to exclude the influence and to measure and control the temperature at sites near the center of the glass stream. When a portion having a cross-sectional area narrowed to no more than 90% is provided, temperature control is made possible at sites near the center of glass stream, which has been difficult to control for conventional nozzles, as well as heat exchange between the center of the glass stream and the glass stream near inner wall.

In order to exclude the influence of the boundary film and to facilitate control the temperature of the center of glass stream, it is more preferable no more than 80%, and most preferable no more than 70%. On the other hand, when the cross-sectional area is excessively narrow, the progress of glass stream may be unduly disturbed, and the flow-rate tends to decrease beyond that required. Therefore, it is preferable no less than 0.1%, more preferable no less than 0.5%, and most preferable no less than 1.0%.

In a forth aspect of the nozzle according to the second or third aspect of the present invention, at least sites, where the center of gravity of cross-section is shifted, exist within 50% of a total length of the nozzle in a downstream side.

An effective function may be derived in cases also where a plurality of sites exists where the center of gravity of cross-section is shifted. For example, when one site exists where the center of gravity of cross-section is shifted, the effect tends to be weaker compared to the case having two sites; however, when the cross-section area is narrowed, the flow rate decreases beyond that required, or a rapid decrease of cross-sectional area of the flow path causes defects such as bubbles and striae; then such problems may be solved and glass shaped bodies may be obtained with superior quality by disposing a plurality of sites where the center of gravity of the cross-section is shifted mildly.

The respective positions of the plurality of sites, where the center of gravity of cross-section is shifted, are decided considering heat conductivity, heat capacity, flow path diameter, flow rate, desirable temperature and temperature distribution of the glass, etc. The respective positions are also dependent obviously on total length of the nozzle; as regards nozzles typically used in the field of optical glass, preferably at least two sites where the center of gravity of cross-section is shifted exist within 50% of the total length of the nozzle in the downstream side, more preferably 45% in downstream side, and most preferably 40% in downstream side.

In a fifth aspect of the nozzle according to any one of the second to fourth aspects of the present invention, a part or all of the sites, where the center of gravity of cross-section is shifted, is formed by disposing a baffle plate(s) at an inner wall of the nozzle, with the thickness of the baffle plate(s) being 0.1 to 10 times of the flow-path diameter at the site(s) where the center of gravity of cross-section is shifted.

As described above, a baffle plate(s) can be used to form the sites where the center of gravity of the cross-section is shifted in the present invention; this way provides an effective means in which manufacturing of nozzles is simple and the effects of uniformalizing temperature, etc. are significant. In such a case, an excessively large thickness of the baffle plate tends to restrict the flow of the glass stream, causing a reason of devitrification or striae by contrast. In addition, an excessively small thickness tends to cause breakage, deformation, etc. due to a lack of durability against the temperature and pressure of the glass stream.

The presence or absence of the phenomena described above depends also on such factors as nozzle diameter, flow rate and flow velocity of glass, and glass viscosity; in regards to nozzles typically used in the field of optical glass, preferably the lower limit of the baffle plate is 0.1 times the flow-path diameter at the site where the center of gravity of the cross-section shifted, more preferably 0.15 times, and most preferably 0.2 times; and the upper limit is preferably 10 times, more preferably 9 times, and most preferably 8 times thereof. In this specification, the term “flow-path diameter” means the diameter in a case where the flow path is circular, and in cases of noncircular, indicates the diameter of an approximated circle having the same area as the flow-path area, i.e. 2 times the square-root of the value taken by dividing the flow-path area by pi.

In a sixth aspect of the present invention, a method for producing a glass shaped body comprises steps of melting a raw material of glass within a bath of molten glass, flowing out the molten glass into a molding tool through a nozzle connected to the bath of molten glass, and molding the glass shaped body, wherein the nozzle is a nozzle according to any one of the first aspect to the third aspect.

In accordance with the sixth aspect of the present invention, the nozzle having the features described above is used in a series of steps for producing optical glass; therefore, glass may be produced with far from having defects such as striae.

In regards to “total length of nozzle” in this specification, the portion connecting a bath of molten glass is the starting point and the point where glass flows out is the ending point thereof. Needless to say, the total length of the nozzle is appropriately changed depending on the size of a bath of molten glass associated with production amount, species of glass, and molding shape. The present invention defines an inner configuration of the nozzles rather than limiting their outer configuration. That is, the exterior appearance of the nozzles, which are not at all limited, may therefore be a linear line, curved line, circular, folded and curved, etc.

The nozzles of the present invention do not exclude heating and/or cooling of the nozzles by themselves and/or by an external additional means. The heating of the nozzles by themselves may be carried out by conventional heating processes such as direct energization of the nozzles, and the external additional means may appropriately utilize conventional means such as gas burners, electric heaters, infra-red irradiation, and radio-frequency heating. In addition, the defects such as devitrification and striae may be suppressed further by covering around the flow outlet of glass with a ring burner, etc. and providing heat insulation.

The means of shaping glass by use of the nozzles of the present invention is not limited specifically. The shaping of optical glass may be carried out by continuously flowing out a glass stream onto a molding tool to continuously shape into plate-like or rod-like glass, or by separating glass gobs by use of a shear or by making use of surface tension, then float-shaping above a porous mold to shape the glass gobs.

The material of the nozzles of the present invention may typically be ones used in glass-melting processes; for example, platinum, reinforced platinum, gold, reinforced gold, rhodium, other precious metals, alloys thereof, and quartz may be used. Furthermore, materials plated by conventional processes may be used, such as platinum of which an inner surface is plated with gold and platinum on which ceramic film like SiC is formed.

The present invention defines the inner configuration of nozzles, and thus the atmosphere around flow outlets of nozzles may be appropriately changed. For example, the atmosphere may be an inert gas atmosphere such as of nitrogen or argon. The flow outlet of the nozzles may be engulfed with a heated atmosphere in some cases.

When the nozzles of the present invention are used, optical glass gobs can be produced free from optical defects such as striae. Furthermore, conventional apparatuses can also be simplified and downsized since the flow rate can be controlled at the site where the center of gravity of cross-section is shifted, in addition to the control of flow rate by diameter or length of conventional pipes.

### BRIEF DESCRIPTION OF THE DRAWINGS

FIG. 1 is an overall view of an apparatus to produce glass shaped bodies;

FIG. 2 is a cross-section view of a conventional nozzle;

FIG. 3 is a cross-section view of a nozzle of the present invention;

FIG. 4 is a cross-section view of a nozzle of the present invention;

FIG. 5 is a cross-section view of a nozzle of the present invention; and

FIG. 6 is a cross-section view of a nozzle of the present invention.

### DETAILED DESCRIPTION OF THE INVENTION

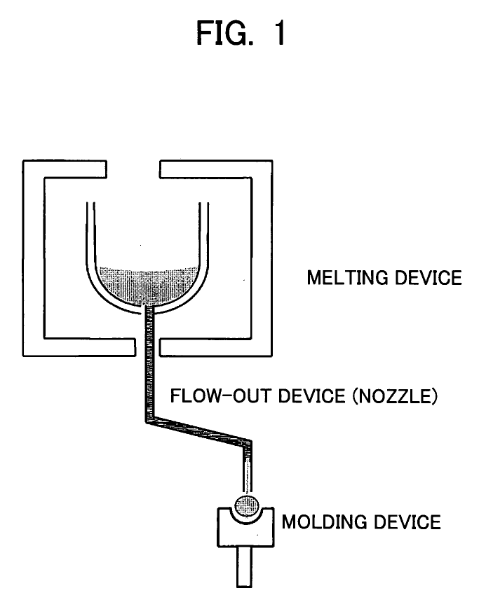

Embodiments of the present invention are explained with reference to FIGS. 1 to 6.

FIG. 1 is an overall view of a glass production apparatus that utilize a nozzle of the present invention. The glass production apparatus includes a melting device, a flow-out device (nozzle) and a molding device. Raw materials of glass are typically poured into a crucible within a melting device, then heated and molten at a predetermined temperature to prepare molten glass. The flow-out device is typically a nozzle made of heat-resistant metal; the molten glass flows out from another end into a molding tool within the shaping device through a flow-out device after optional treatments of clarification, defoaming, stirring, etc. The molding tool may be of various configurations depending on the preforms to be produced. For example, when plate glass is produced, the molten glass flows down as a continuous flow onto an substantially quadrangle molding tool, and when being float-shaped, in general, the molten glass is dropped on a porous molding tool having circular depressions.

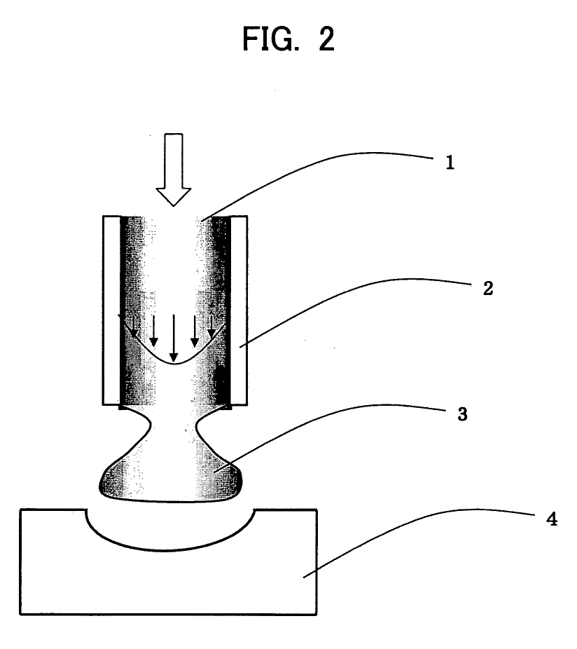

FIG. 2 represents a cross section of a conventional nozzle. 1 represents molten glass, 2 represents a nozzle, 3 represents a dropping glass gob, and 4 represents a molding tool to receive the dropped glass gob. A plurality of arrows within the molten glass expresses the temperatures of molten glass in relation to the lengths of the arrows.

As shown in FIG. 2, the temperature of molten glass is higher toward the central portion of the nozzles, and the temperature decreases and thus the viscosity increases toward the inner wall of nozzles; therefore, the dropped glass gob is mainly of the higher temperature portion that drops from around the central portion. The reason to take such a distribution is that higher temperature portions and lower temperature portions are not significantly mixed and far from being able to exchange heat in the configuration of conventional nozzles. It is also difficult with conventional nozzles to correctly measure and control the temperature of glass stream center. The resulting glass forming glass gobs tends to cause striae, because of no control into an appropriate temperature distribution.

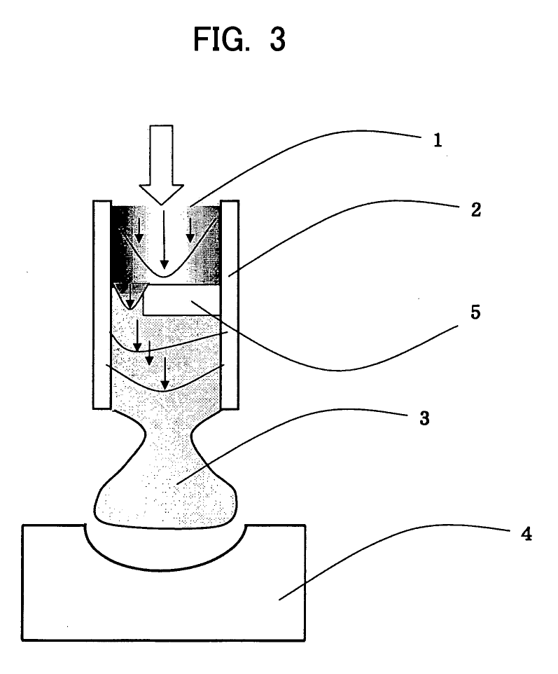

FIG. 3 represents a cross section of an embodiment of the nozzle of the present invention. In the nozzle shown in FIG. 3, a baffle plate 5 is provided at a site inside the nozzle that restricts a portion of flow path to rapidly change the flow direction. Therefore, the flow path is discontinuously narrowed at the site where the baffle plate 5 is disposed, and the center of the flow path at the site is shifted from the center of the flow path at the upstream.

When such a configuration is employed, the flow path of the higher-temperature glass stream, which has flowed through around the upstream center of the nozzle, is forcibly shifted to around the inner wall of the nozzle; in this case, the difference of flow velocity from the lower-temperature glass stream, which had flowed originally through around the inner wall of the nozzle, is reduced. Consequently, the temperature of the glass is more uniformalized in the nozzle. When passing through the baffle plate 5, the glass stream is uniformalized in terms of the temperature distribution, and also the temperature can be measured and controlled more accurately; therefore, when the glass gobs are flowing down, a higher-temperature glass stream or inadequate temperatures, which may induce striae, is unlikely to occur. The glass stream passes through the narrow flow path formed by the baffle plate 5 in FIG. 3; accordingly, the flow path formed by one baffle plate 5 is not defined as one site, as long as the effect to shift the flow path is adequately derived.

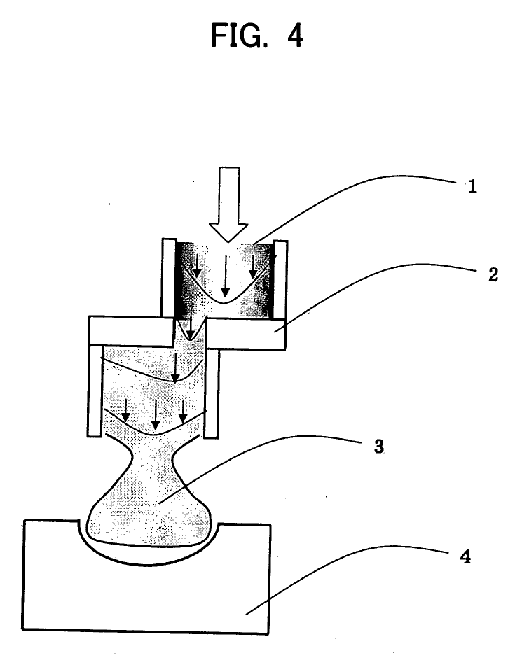

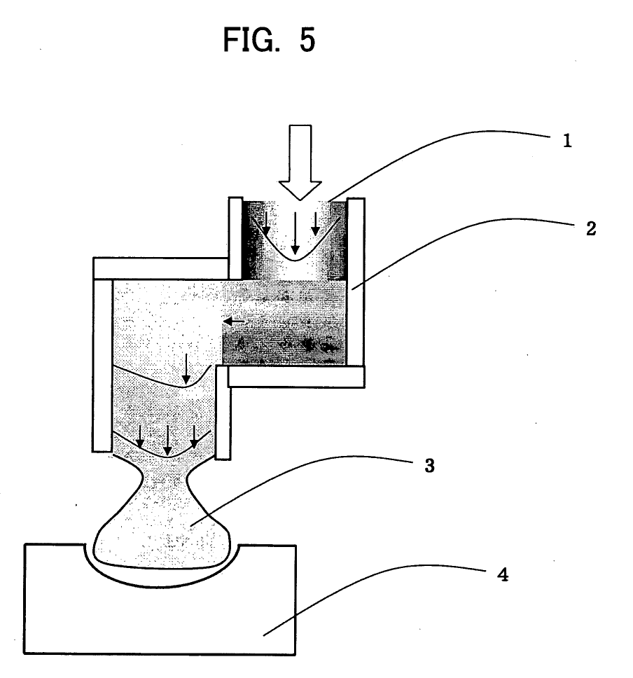

FIGS. 4 and 5 represent cross sections of other embodiments of the nozzles of the present invention. In the embodiment shown in FIG. 3, the center of gravity of the cross section aligns relative to the upstream and the downstream of the site where changing the flow path of the glass stream, whereas, in the embodiments shown in FIGS. 4 and 5, the flow path does not align once being changed and the glass stream flows in another flow pass; either embodiments of the present invention may be employed. In these cases, the narrow flow path formed by shifting the flow path is not defined as one site.

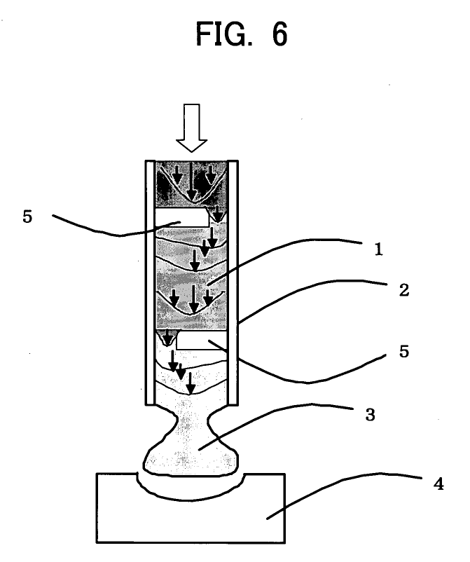

FIG. 6 shows an embodiment in which a plurality of baffle plates 5 is disposed within a nozzle, and the normalizing of the temperature distribution is promoted by way of increasing the stirring effect on the glass stream using two baffle plates. The baffle plates may be disposed in the same or different directions to each other.

### EXAMPLES

Specific examples of the present invention are explained in the following.

### Example 1

In this Example, an optical glass was molten within a crucible, the molten glass was flowed through a nozzle connected to the crucible and flowed out from the terminal flow outlet, and was float-shaped on a molding tool, which was ejecting gas and made of porous stainless steel, thereby obtaining glass gobs to use as a preform for precision press molding.

The nozzle in use was a platinum nozzle having the same structure as shown in FIG. 3 described above. The inner diameter of the nozzle without the baffle plate 5 was 3 mm (cross-section area: 7.07 mm²), and the flow outlet was expanded to 6 mm. The total length of the nozzle, i.e. the length from the outlet of the nozzle to the flow outlet of the nozzle end, was 2 m.

The baffle plate was attached within the nozzle at the site of 47 mm from the flow outlet, and the thickness of the baffle plate was 1 mm. The area of the glass flow path was 0.79 mm² at the portion where the baffle plate was attached. That is, the cross-sectional area of the flow path where the baffle plate is attached was about 11% based on that of the other area.

The receiving mold was made of porous stainless steel; glass gobs were obtained by way of receiving the molten glass under a condition of ejecting air from the receiving surface, thereby receiving the molten glass in a condition of floating on the receiving mold.

The glass in use was prepared by melting an optical glass mainly containing boron oxide and lanthanum oxide. The crucible was maintained at approximately 1200° C., and the flow-out pipe was maintained at approximately 1100° C. The molten glass was made under the condition of separating into droplets from the flow outlet. The flow rate of the molten glass was 80 grams per minute at this time.

The glass gobs were visually observed with respect to optical defects such as devitrification and striae; as a result, such defects could not be found, and the glass gobs were of high quality available as preforms for forming optical elements.

### Comparative Example

A Comparative Example is shown in comparison to Example 1. Glass gobs were obtained in the same manner as Example 1, except that no baffle plate was disposed within the nozzle.

The glass gobs were visually observed with respect to optical defects such as devitrification and striae; as a result, the existence of striae could be visually confirmed, and the quality of the glass gobs was inadequate for a raw material to form optical elements.

### Example 2

Glass gobs were obtained in the same manner as Example 1, except that baffle plates were disposed at two sites of 30 mm and 90 mm from the flow outlet within the nozzle. The thickness of each of the baffle plates was 1 mm. The resulting glass gobs were high-quality glass gobs similar to Example 1, and no optical defects such as devitrification and striae could be visually observed.

1. A nozzle, which is connected to a bath of molten glass to flow out the molten glass, wherein a site is disposed where a center of gravity of a cross-section thereof perpendicular to a flow-out direction of the molten glass in a flow path within the nozzle is shifted from a center of gravity of a cross section of an upstream side.

2. The nozzle according to claim 1, wherein a plurality of sites is disposed where the center of gravity of cross-section in the flow path is shifted.

3. The nozzle according to claim 1, wherein at least one site, where the center of gravity of the cross-section is shifted, has a cross-sectional area of a flow path of no more than 90% based on the cross-section area of a flow path of the upstream side.

4. The nozzle according to claim 2, wherein at least two sites, where the center of gravity of the cross-section is shifted, are disposed within 50% of a total length of the nozzle in a downstream side.

5. The nozzle according to claim 4, wherein at least a part of the sites, where the center of gravity of the cross-section is shifted, is formed by disposing a baffle plate(s) at an inner wall of the nozzle, and a thickness of the baffle plate(s) is 0.1 to 10 times of a flow-path diameter at the site where the center of gravity of the cross-section is shifted.

6. A method for producing a glass shaped body, comprising steps of: melting a raw material of glass within a bath of molten glass; flowing out the molten glass into a molding tool through a nozzle connected to the bath of molten glass; and molding the glass shaped body, wherein the nozzle is a nozzle according to claim 1.
